(19) United States
(12) Patent Application Publication
(10) Pub. No.: US 2006/0105789 A1
(43) Pub. Date: May 18, 2006

(54) Websites mapping system and method

(76) Inventor: Noah Amit, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/992,937

(22) Filed: Nov. 18, 2004

(51) Int. Cl. H04Q 7/20

(52) U.S. Cl. 455/456.6

(57) ABSTRACT

A method and system of accessing websites data by cellular telephones. A cellular telephone communicates with global positioning devices so that the geographical location of the cellular telephone at a given time is recorded. A database is provided containing information regarding websites classified according to the geographical location of the places of business related to the websites. A prompt is provided on the cellular telephone to download to the cellular telephone websites related to places of business which are located in the geographical vicinity of the recorded geographical location at the given time.

### FIELD OF THE INVENTION

The present invention relates to an extended application of GPS enabled cellular telephones.

### BACKGROUND OF THE INVENTION

Internet enabled cellular telephones, also labeled as “Third Generation” (3G) telephones, are in the process of becoming standard in many of the developed countries. Hence, users can surf through the World Wide Web the same way as experienced with desk or portable computers.

Also, a trend to equip cellular telephones with GPS and other location based techniques and facilities is evident and expected to become standard. Users can link to the satellite network of the GPS and obtain immediate information regarding their geographic location with accuracy of a few meters.

Turning to another angle of modern life, shopping habits have vastly changed in the last years. Customers have learned to use the e-shopping, namely to buy goods through the websites of traders. This is true for all classes of purchasing, ranging from daily groceries to automobiles and plots of land. One can hardly run a serious business now days without promotion by a website, with or without interactive purchasing facilities.

Even so, however, a substantial portion of the public, for practical, psychological and other reasons, still adhere to the conventional shopping process, namely to be present in the marketplace, see and feel the objects of their interest and then make their buying decision. Hence, in spite of the tremendous development of e-shopping, stores, shopping-malls and shopping-centers are not likely to disappear in the foreseen future.

With regard to service providers (banks, doctors, lawyers, etc.), these are inherently outside of the e-shopping range but still use websites to promote their accessibility to the potential public.

### OBJECTS OF THE INVENTION

Bearing in mind this factual background, it is the prime object of the invention to integrate the internet surfing facilities of cellular telephones with the GPS facilities in order to achieve a location-based websites identification.

It is a further object of the present invention to enable individual cellular phone holders to automatically and dynamically download websites which are associated with places of commerce located in the immediate vicinity of the holder.

It is a still further object of the invention to convert a location reading via the GPS system into downloading one or more commercial websites associated with the respective location.

It is a still further object of the invention to establish, with respect to any given area or zone, a database of location-oriented commercial websites and means for constantly providing the relevant information (i.e. downloaded websites) to the cellular telephone holder as he nears the business place of respective website owner or owners.

It is a still further object of the present invention to provide for a scale preference in cases where more than one website is associated with a given geographical location, e.g. to give preference in downloading the website of an owner who subscribed to the services of the database managers over others who did not; or to the websites that gained more popularity (number of recent entries); or who offer special deals; etc as will be explained in more detail below.

### SUMMARY OF THE INVENTION

Thus provided according to one aspect of the invention is a method of accessing websites data by cellular telephones comprising the steps of enabling the cellular telephone to communicate with global positioning means whereby the geographical location of the cellular telephone at any given time is recorded; providing a database containing information regarding websites classified according to the geographical location of the places of business related to the websites; and prompting the downloading by the cellular telephone of websites related to places of business which are located in the geographical vicinity of the recorded geographical location at said given time.

According to another aspect of the invention there is provided a method of forming the said database comprising the steps of systematically scanning websites by “smart agent” means; identifying and sorting-out details contained in the websites which pertain to the local address of the places of business related to the websites; matching the websites with the geographical coordinates of said addresses; and forming a directory of geographical coordinates versus the relevant websites.

According to a still further aspect of the present invention, there is provided a system for accessing websites data by cellular telephones comprising means for enabling the cellular telephone to communicate with global positioning means whereby the geographical location of the cellular telephone at any given time is recorded; a database containing information regarding websites classified according to the geographical location of the places of business related to the websites; and means for prompting the downloading by the cellular telephone of websites related to places of business which are located in the geographical vicinity of the recorded geographical location at said given time.

### BRIEF DESCRIPTION OF THE DRAWINGS

These and additional features and advantages of the invention will become more clearly understood in light of the ensuing description of a preferred embodiment thereof, given by way of example only, with reference to the accompanying drawings, wherein:—

FIG. 1 is a schematic representation of the system and usage thereof proposed according to the general principles of the present invention;

FIG. 2 is a flow-chart illustrating the usage of the system; and

FIG. 3 is a flow-chart relating to the compilation of the database useful in the application of the present invention.

### DETAILED DESCRIPTION OF THE PREFERRED EMBODIMENT

As already briefly stated above, the launching platform of the present invention is constituted by a database on the one hand, and a cellular telephone GPS driven browser that enables the linking between the location of the telephone and the respective websites on the other hand (hereinafter called CLBB for Cellular Location Based Browsing).

CLBB by itself is known, e.g. in the field of vehicular navigation (for civil or military uses). In this case, the database contains maps, say of streets within a given town zone. The maps are downloaded to the cellular telephone in response to the location co-ordinates of the GPS enabled telephone, and changes according to the holder's movements. Maps databases are offered for free use by organizations such as Yellow Pages and other enterprises of certain countries.

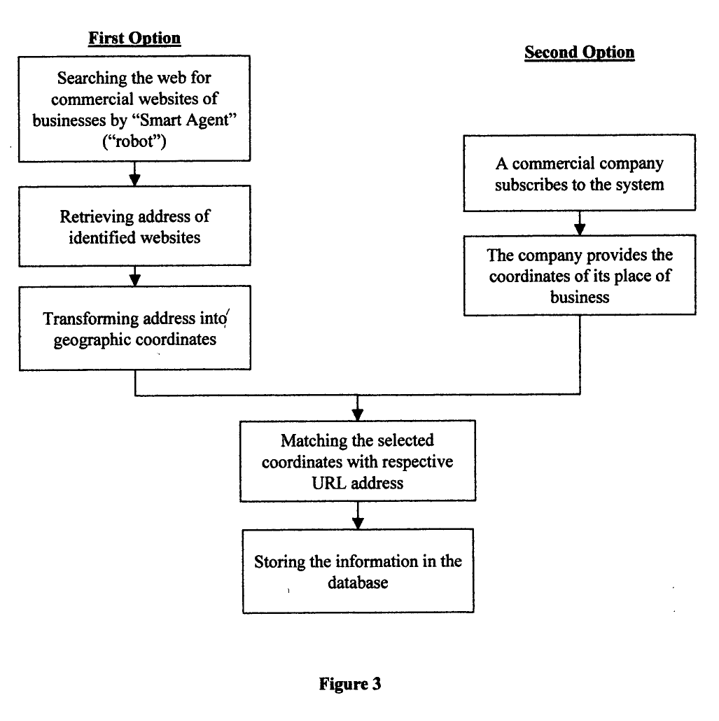

What is therefore required for the reduction of the present invention into practice is the substitution of the current information of geographic data (XY coordinates) by website data of business places residing at the respective location. The generation of the database requested for that purpose can be performed by various methods as will be briefly discussed in conjunction with FIG. 3.

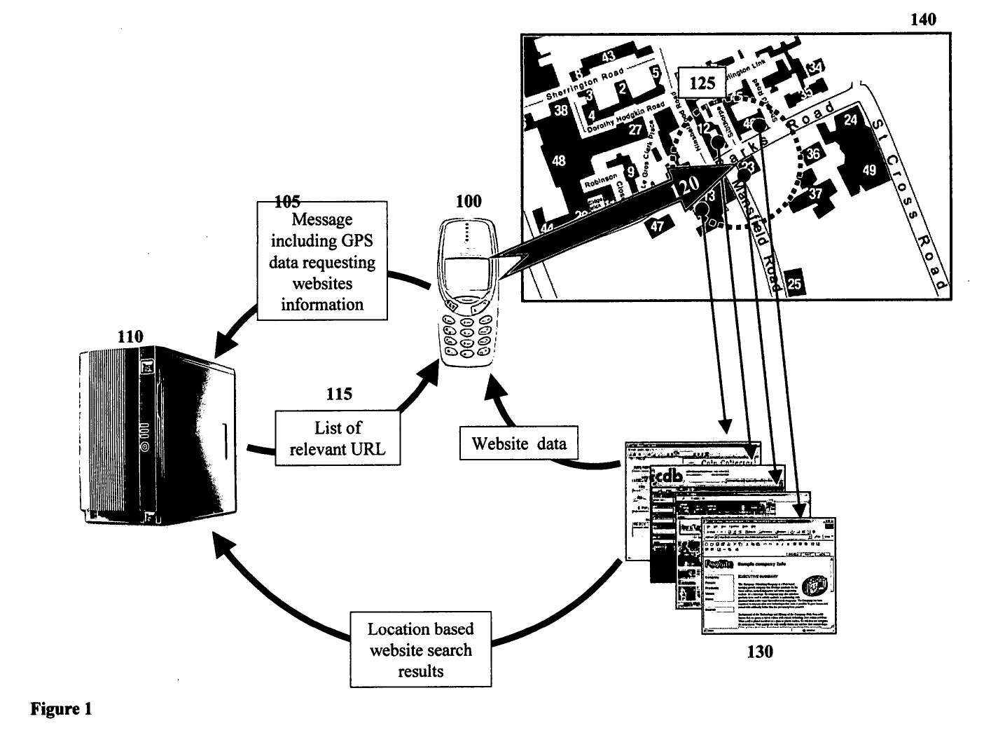

The major components of the system and the layout thereof are schematically shown in FIG. 1. Cellular phone 100 of the 3^{rd} generation and GPS enabled is positioned near an address 120 of a typical urban zone 125 shown on map 140. Let us assume that at this address there are located several stores or the like business places, each one owning a commercial website (four examples are illustrated collectively designated 130).

Server 110 communicates with the phone 100 via what is known as wireless Wide Area Network (WAN). The server 110 hosts the addresses/websites directory mentioned above.

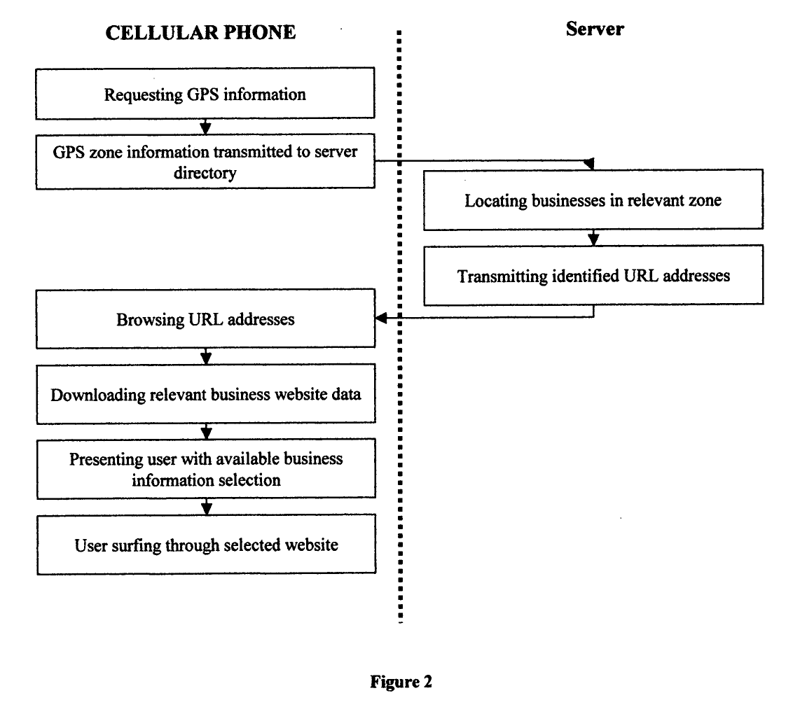

The operation of the system is illustrated by the flow chart of FIG. 2. Once access to the Internet is established by the user of the phone 100, the GPS application automatically retrieves the coordinates of the position of the cellular phone 100. The user may now send a message to the system's server 110 containing the location coordinates and a request for websites information. The server directory retrieves from its database the URL addresses of businesses located within the predetermined search radius 125 around the coordinates of the phone 100. The server transmits the URL addresses of all businesses which are located in the predefined area. Once receiving the list, the user of the phone 100 is enabled to browse through it and select one of interest. Selecting a URL address automatically downloads the relevant website. The business information contained in the website is made available to the user for surfing therethrough.

Once the user has focused on a particular website or any link thereof, he need not just make the decision whether he wishes to physically visit the identified place of business, but to further refine the information; for example, he may wish to know whether a certain item is in fact on sale, and at what price; where exactly is it displayed (e.g. storey in a department store); or, alternatively, what special deals are presently offered including their terms, etc. The user can accomplish all this without making any further step.

It is foreseen in the present context that businesses will adapt to this novel “hybrid” method of shopping, and design their websites accordingly. For example, they may offer significantly improved terms to those who make an actual purchase within a given, short, period of time (say 15 minutes) counted from the downloading of their website (which is only feasible for those already located nearby the store and not just surfing from their homes).

Numerous other options and applications become available using the method herein disclosed. Following are a few examples.

The user may define online the radius in which the server searches for businesses, thereby determining the overall size of the relevant area (circle 125 in FIG. 1).

The user may request that the search for surrounding websites be limited to specific types of businesses, say restaurants; hairdresser salons; hotels; theaters; or even to a specific product of his interest.

In fact, and as a byproduct of the system, the yielded database can be regarded and used as an extremely convenient and user-friendly directory or index enabling the tracing of any information of interest as a function of the XY coordinates relating thereto.

From the commercial angle of the organization that will provide the services of the present invention, other pre-set categories may be taken into account, such as giving preference to business places who subscribed and paid for being included in the websites databases.

As already mentioned, the operation of the present invention depends on the reliability and accessibility to the database containing records of businesses' URL addresses and the geographic coordinates of the stores and offices of those businesses.

Two optional methods for attaining this information are represented in FIG. 3. First, the server operates a smart agent (also known as a “robot” or “crawler”), searching for commercial websites. Upon identification, the system translates these locations into geographic coordinates. This process will be conducted in an “intelligent” manner, meaning that each website, including every link included therein, should be progressively analyzed to identify all address-related pieces of information such as zip-codes, storey and/or wing of the building in question, etc. The information will be systematically organized in the complete database for the purposes of quick and clear retrieval upon request of the user.

According to a second option (or in addition to the first option), businesses who wish to subscribe to the organization which provides this service, will supply the coordinates of their offices and stores during the registration.

Having attained the information, the system creates records which contain the business's description, their URL address and geographic locations which are stored in the database.

In summation of all the above, the options offered by the present invention will probably open a new era in shopping and other information retrieval habits of the public at large.

Those skilled in the art to which this invention pertains, will readily appreciated that numerous changes, variations and modifications can be effected without departing form the true spirit and scope of the invention as defined in and by the appended claims.

What is claimed is:

1. A method of accessing websites data by cellular telephones comprising the steps of—
enabling the cellular telephones to communicate with global positioning means whereby the geographical location of the cellular telephone at any given time is recorded;
providing a database containing information regarding websites classified according to the geographical location of the places of business related to the websites; and
prompting the downloading by the cellular telephone of websites related to places of business which are located in the geographical vicinity of the recorded geographical location at said given time.

2. The method as claimed in claim 1 comprising the further step of enabling the user of the cellular telephone to define the limits of said vicinity within which the said downloading shall occur.

3. The method as claimed in claim 1 comprising the further step of enabling the user of the cellular telephone to define a class of interest whereby only websites pertaining to that class shall be downloaded.

4. The method as claimed in claim 1 wherein the websites relate to goods/services providers.

5. A method of forming the database recited in claim 1 comprising the steps of—
systematically scanning websites by “smart agent” means;
identifying and sorting-out details contained in the websites which pertain to the local address of the places of business related the websites;
matching the websites with the geographical coordinates of said addresses; and
forming a directory of geographical coordinates versus the relevant websites.

6. A system for accessing websites data by cellular telephones comprising:—
means for enabling the cellular telephone to communicate with global positioning means whereby the geographical location of the cellular telephone at any given time is recorded;
a database containing information regarding websites classified according to the geographical location of the places of business related to the websites; and
means for prompting the downloading by the cellular telephone of websites related to places of business which are located in the geographical vicinity of the recorded geographical location at said given time.

7. The system as claimed in claim 6 further comprising means for enabling the user of the cellular telephone to define the limits of said vicinity within which the said downloading shall occur.

8. The system as claimed in claim 6 further comprising means for enabling the user of the cellular telephone to define a class of interest whereby only websites pertaining to that class shall be downloaded.

9. The system as claimed in claim 6 wherein the websites relate to goods/services providers.
